(19) United States
(12) Patent Application Publication
(10) Pub. No.: US 2008/0120416 A1
(43) Pub. Date: May 22, 2008

(54) SYSTEM AND METHOD FOR PEER TO PEER COMPENSATION

(75) Inventors: Samuel P. Hopkins, Freedom, PA (US); Robert J. Boback, Moon Township, PA (US); Christopher L. Gormley, Wexford, PA (US)

Correspondence Address: Daniel H. Golub, 1701 Market Street, Philadelphia, PA, 19103, US

(73) Assignee: TIVERSA, INC., Cranberry Township, PA (US)

(21) Appl. No.: 11/935,757

(22) Filed: Nov. 6, 2007

Related U.S. Application Data
(60) Provisional application No. 60/857,337, filed on Nov. 7, 2006.

(51) Int. Cl. G06F 15/173; G06F 15/16

(52) U.S. Cl. 709/226; 709/229; 709/224

(57) ABSTRACT

A system and method for compensating content owners and users that share content on a peer to peer (P2P) network. An enrollment system is accessed over the P2P network for registering a plurality of users and content owners, and establishing a financial account for each user and content owner that registers using the enrollment system A compliance system, coupled to the P2P network, monitors transmission of items of shared content from nodes in the P2P network and receipt of items of shared content by nodes in the P2P network and, upon detection of the transmission of a shared item of content: (i) credits an account of a first user for transmission of the shared item of content; (ii) credits an account of a content owner for transmission of the shared item of content; and (iii) charges an account of a second enrolled user for receipt of the shared item of content.

### CROSS-REFERENCE TO RELATED APPLICATION

The present application claims priority to U.S. Provisional Application No. 60/857,337 entitled “System and Method for Peer-to-Peer Compensation,” filed Nov. 7, 2006, incorporated herein by reference.

### FIELD OF THE INVENTION

The present invention provides a system and method for compensating users on a peer-to-peer network for making information available and for the transmissions of information.

### BACKGROUND OF THE INVENTION

As used herein, peer-to-peer networks which are one of the subjects of the present invention comprise multiple nodes, each node typically consisting both of file server and client that can send and receive data or “Communication messages” to or from a node to which such is connected and other nodes on the network. Common peer-to-peer networks and software applications are Gnutella, FastTrack, Edonkey, NeoNet, Kazaa, Limewire, Morpheus, Bear Share, Bit Torrent, Shareaza, Emule, and Freenet. This list is not inclusive of all peer-to-peer file applications but rather serves as a general list.

Popular music, movies, or other works are easy to find and purchase at physical stores or on the Internet. Unpopular music, movies, and other works are not easy to find because they are either out of print, production, or it is cost prohibitive to house or offer the information. Typically shelf space, digital storage, and digital bandwidth are allocated to the popular music and movies that the majority of people are purchasing. While the majority of music, movies, and other works are available, people still look to purchase or acquire lesser known works. It is clear that the rapid growth of digital content is outpacing the storage and delivery capabilities of current retail delivery models.

Some people have lesser known music or movies stored on physical mediums such as CD's, records, or tapes which could be digitized and placed onto the peer-to-peer network for others to find. Some people already have digitized their collections but have not made them available to the peer-to-peer. It would therefore be advantageous if users of the peer-to-peer network would digitize their works and/or make their collections available to the peer-to-peer as other users would be interested in acquiring the music or movies but do not have access to purchase doe to the limited distribution of the music or movies. It would also be advantageous if users placing information on the Peer-to-Peer network would receive some form of compensation for doing so.

Some users would like to share digital content of themselves or situations in which they participated in. Some examples are movies or family recipes. Some users have collections of information of a specific topic. It would be advantageous if the users had a medium to display and offer his digital content for the acquisition of other users such as on the peer-to-peer network. It would also be advantageous if the user could make this information available to other users of the peer-to-peer network and get compensated for it.

Peer-to-peer networks are commonly used to share copyrighted works such as movies, music, software and ebooks. When a copyrighted work is transferred from one user to another illegally, the copyright holder does not receive any compensation for the transfer. It would be advantageous when a copyrighted work is transferred from one user to another that the copyright holder would receive some form of compensation.

On a peer-to-peer network, users store information and transfer this information to other users of the peer-to-peer network when asked. The information being transferred from user #1 to user #2 is stored on user #1's computer system and utilizes user #1's bandwidth for the transmission. It would also be advantageous if user #1 would receive compensation each time they transferred a file. Collectively it would be advantageous for the existence of a system that could charge a receiving user for the transfer and compensate the sending user and the copyright holder.

While compensation peer-to-peer services exist, users tend to utilize the free peer-to-peer networks where they can acquire information free if they want. Users also generally do not want to switch to a different peer-to-peer application, or utilize an application that would limit the scope of the information available. The preferred embodiment of the invention allows the user to use the peer-to-peer application of their choosing.

### SUMMARY OF THE INVENTION

The present invention is directed to a system and method for compensating content owners and users that share content on a peer to peer (P2P) network. An enrollment system is accessed over the P2P network for (i) registering a plurality of users including a first enrolled user and a second enrolled user, wherein each of the plurality of users sends or receives one or more items of shared content using a node on the P2P network, (ii) registering a plurality of content owners that own at least some of the items of shared content, said plurality of content owners including a first enrolled content owner, and (iii) establishing a financial account for each user and content owner that registers using the enrollment system, wherein each financial account has information for crediting or debiting a user or content owner in response to the sharing of content on the P2P network. A compliance system, coupled to the P2P network, monitors transmission of items of shared content from nodes in the P2P network and receipt of items of shared content by nodes in the P2P network and, upon detection of the transmission of a shared item of content, owned by the first enrolled content owner, from the first enrolled user to the second enrolled user, the compliance system: (i) credits a financial account of the first enrolled user for transmission of the shared item of content; (ii) credits a financial account of the first enrolled content owner for transmission of the shared item of content; and (iii) charges a financial account of the second enrolled user for receipt of the shared item of content.

In some embodiments, at least some of the enrolled users are anonymous with respect to other enrolled users, and a certification ranking is generated for at least some of the enrolled users based on statistics associated with prior transactions conducted by the enrolled users over the P2P network. The certification ranking is provided to other enrolled members desiring to obtain shared content over the P2P network.

In some embodiments, the compliance system is implemented using at least one external inline filter logically positioned between the first enrolled user and the P2P network. In such embodiments, the compliance system detects transmission of a shared content item by detecting transmission of a tagged file associated with the shared content item. The tagged file optionally includes information indicating a condition of the shared item of content.

In some embodiments, the compliance system adds or modifies a cookie on a browser of the first enrolled user based on search requests issued by the first enrolled user or shared items of content transmitted by the first enrolled user. In such embodiments, the cookie is optionally used to deliver a targeted advertisement to the first enrolled user.

In some embodiments, the compliance system disables transmission of content that is not authorized for sharing on the P2P network. In some embodiments, the first enrolled content owner and the first enrolled user are the same. In some embodiments, at least one file with content owned by the enrolled content user is tagged with an identifier that causes the compliance system to credit the account of the enrolled content owner each time the file tagged with the identifier is transmitted from one enrolled user to another enrolled user.

Other advantages of the present invention will become apparent from a perusal of the following detailed description of presently preferred embodiments of the invention.

### BRIEF DESCRIPTION OF THE DRAWINGS

FIG. 1 is a diagram showing a method for implementation of the present invention.

### DESCRIPTION OF PRESENTLY PREFERRED EMBODIMENTS

The present invention provides a system and method for compensating users of a peer-to-peer network for sharing information and for charging users that receive information from a peer-to-peer network. It further provides a method for compensating a copyright holder when information is transferred from a sending user to a receiving user. Other advantages of the present invention will become apparent from a perusal of the following detailed description of presently preferred embodiments of the invention.

Generally the invention is comprised of a collection of systems and processes, which comprises a means to register, a means to compensate, and a means to track transactions. Collectively these are referred to as the “Total System.”

The Registration System provides a means for the registration of users so that they can participate in the Total System. Users could supply information that allows them to be compensated for sharing a file. Users could also supply information that allows them to be charged for receiving a file. Generally the information they would supply is a credit card number, banking account number, or other means of a value containment system. The system may also work on credits.

The Compensation System provides a means for transferring money, credits, or some other form of compensation from a receiving user to a sending user, and a copyright holder, or other owner of the information. It could also be used to hold accounts that contain money, credits, or some other form of compensation or ranking.

The compliance system in the preferred embodiment is a software application that resides on the same device as the peer-to-peer client application. It is configured to monitor the sending of a file from a sending user and the receiving of a file from the receiving user. It is also responsible for notifying the Total System, or a portion of the Total System that an event has occurred. The Total System could for example then transfer credits from one account to another, or compensate a copyright holder, or the owner of the information.

Because the peer-to-peer network is usually anonymous, a ranking system or verification/certification system would be advantageous. For example, a participant with good standing in the Total System could be flagged as being legitimate or one who offers good customer service. The participant could also be tagged with the number of transactions they have completed. The participant could also be placed into a group based on some statistics such as number of transactions. These groups could have names to help other participants identify their standing.

In one preferred embodiment of the present invention, the invention comprises the means for user registration, a means for compensation, and a means for enforcing transactions of the participants.

The Registration System is a website, server, system, or software application that provides an interface that allows participants to register and record identifiable information about themselves such as name, address, password, and account numbers. The participant could also register specific attributes about likes and/or dislikes.

The compensation system is a system that allows the compliance system to transfer information to it regarding transactions and then act upon this information. Actions taken could include paying the user transmitting the information, charging the receiver of the information, or compensating the copyright holder or other owner of the information.

The compliance system is a software application that is installed on the same system as the peer-to-peer client application and has a means for monitoring and affecting the transmission of files. In the preferred embodiment of the invention, the software application acts as an external inline filter, separate and apart from the peer-to-peer application that monitors any transmissions exiting the peer-to-peer system. For example if the peer-to-peer application is utilizing the Ethernet network card of a computer system the compliance system application would monitor the packets that are being transmitted out the Ethernet card. It could also monitor the IP stack. It could also monitor inter/intra communications of the applications running on the peer-to-peer system.

The compliance system operates when the peer-to-peer application is operating. The compliance system maintains a connection with the registration system or has a means to connect to the registration system when an event occurs. The compliance system supplies the registration system with a token that identifies the user and information about transactions.

When the compliance system detects that a file is being transmitted to another user it notifies the compensation system that a file is being transferred. When the compliance system detects that a file is being received from another user it notifies the compensation system that a file is being acquired. The compensation system then correlates the sender with the receiver and compensates the sender, charges the receiver, and compensates the copyright holder or other owner of the information. To identify the File that was transferred or received, the compliance system can use the filename of the file being transferred, a hash of the file, a marker on the file, the contents of the file, or other attributes.

In another embodiment of the present invention, the compensation does not correlate the sending of information with the receiving information. It merely compensates the sender of the information, charges the receiver of the information, or compensates the copyright holder.

In another embodiment of the present invention, the user has a means for tagging a file with information so that the Compliance System recognizes the file.

In another embodiment of the present invention, the user has a means for tagging a file with information so that the Compliance System recognizes the file as chargeable.

In another embodiment of the present invention, the user has a means for tagging a file with information so that the Compliance System recognizes the file as free.

In another embodiment of the present invention, the user has a means for tagging a file with information so that the Compliance System recognizes the file as a partial form, lower quality, or demo.

In yet another embodiment of the present invention, the Compliance System stops transmissions of a file from a sender that is participating in the Total System and a receiver that is a non-participant.

In yet another embodiment of the present invention, the peer-to-peer client application connects to the Compliance System and the Compliance System connects to the peer-to-peer network.

In yet another embodiment of the present invention, the Compliance System collects information regarding habits or statistic. For example the Compliance System could collect searches or files that were received.

In yet another embodiment of the present invention, the Compliance System application can also contain logic that allows it to connect to other services other than the Total System.

In yet another embodiment of the present invention, the Compliance System application can add or modify a WWW cookie in the users World Wide Web browser. This could be used for target marketing or to enhance the participants World Wide Web experience.

In yet another embodiment of the present invention, the Compliance System monitors traffic from the peer-to-peer application and when it detects information that should not be shared it disables the transmission. For instance if it detects credit card information being transmitted.

In yet another embodiment of the present invention, the Compliance System can be configured to only allow the transmission of marked or specifically authorized files. If it detects any other files it can notify the user or block the transmission.

In yet another embodiment of the present invention, the compensation system can record or collect information relating to what files are being transmitted and compensated for.

In yet another embodiment of the present invention, the Compliance System is built into the peer-to-peer application.

In yet another embodiment of the present invention, the Compliance System is an add on or plugin application to the peer-to-peer application.

In yet another embodiment of the present invention, participants or the Total System can rank other participants. This can be automatic or by a voting system. Ranking could be based on transaction statistics, number of works acquired from a participant, number of works a participant has acquired, size of participant's collection, length of time participating, a certification. Types of certification include being certified by proof of identity, email address confirmation, or length of participation. Furthermore, participants may be grouped together based on variations of these ratings. These groups may be named, such as “Power Performer” or “Power Sharer”.

In yet another embodiment of the present invention, a community of participants is created that consist of participants creating collections of information and offering this information for sale on the peer-to-peer network.

In yet another embodiment of the present invention, a system is created where the cost of a work is set by means of an auction.

In yet another embodiment of the present invention, a file is tagged with an identification which allows a participant to be continuously compensated each time a file is shared and a transaction takes place. This would aim to protect an originating source from their works being re-shared without just compensation.

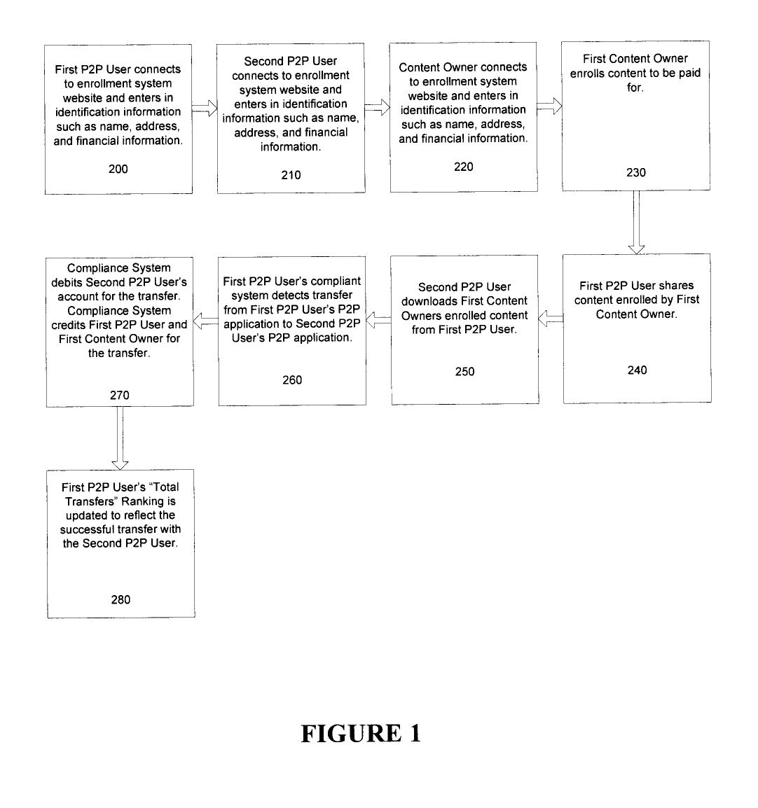

Referring now to FIG. 1, there is shown a diagram of a method for implementation of the present invention. In steps 200, 210, first and second P2P users access an enrollment system over the P2P network in order to register. The registration includes, e.g., entry by the users of identification information such as name, address and bank/credit card information. In steps 220, 230, a content owner registers by, e.g., entering the content owner's identification information such as name, address and bank/credit card information. In step 240, the first P2P user shares content owned by the content owner with the second P2P user; and in step 250 the shared content is downloaded by the second P2P user. In step 260, a compliance system (e.g., an external inline filter logically positioned between the first enrolled user and the P2P network), detects of the transmission of the shared item of content, owned by the content owner, from the first P2P user to the second P2P user. In step 270, the compliance system: (i) credits the financial account of the first P2P user for transmission of the shared item of content; (ii) credits the financial account of the content owner for transmission of the shared item of content; and (iii) charges a financial account of the second P2P user for receipt of the shared item of content. In step 280, a certification ranking for the first P2P user is updated to reflect the successful transfer with the second P2P user.

Finally, it will be appreciated by those skilled in the art that changes could be made to the embodiments described above without departing from the broad inventive concept thereof. It is understood, therefore, that this invention is not limited to the particular embodiments disclosed, but is intended to cover modifications within the spirit and scope of the present invention as defined in the appended claims.

What is claimed is:

1. A method for compensating content owners and users that share content on a peer to peer (P2P) network, comprising:
(a) using an enrollment system that is accessed over the P2P network to register a plurality of users including a first enrolled user and a second enrolled user, wherein each of the plurality of users sends or receives one or more items of shared content using a node on the P2P network;
(b) using the enrollment system to register a plurality of content owners that own at least some of the items of shared content, said plurality of content owners including a first enrolled content owner;
(c) establishing a financial account for each user and content owner that registers using the enrollment system, wherein each financial account has information for crediting or debiting a user or content owner in response to the sharing of content on the P2P network; and
(d) using a compliance system, coupled to the P2P network, to monitor transmission of items of shared content from nodes in the P2P network and receipt of items of shared content by nodes in the P2P network; wherein, upon detection of the transmission of a shared item of content, owned by the first enrolled content owner, from the first enrolled user to the second enrolled user, the compliance system:
(i) credits a financial account of the first enrolled user for transmission of the shared item of content;
(ii) credits a financial account of the first enrolled content owner for transmission of the shared item of content, and
(iii) charges a financial account of the second enrolled user for receipt of the shared item of content.

2. The method of claim 1, wherein at least some of the enrolled users are anonymous with respect to other enrolled users, said method further comprising: generating a certification ranking for at least some of the enrolled users based on statistics associated with prior transactions conducted by said enrolled users over the P2P network, and providing the certification ranking to other enrolled members desiring to obtain shared content over the P2P network.

3. The method of claim 1, wherein the compliance system is implemented using at least one external inline filter logically positioned between the first enrolled user and the P2P network.

4. The method of claim 3, wherein the compliance system detects transmission of a shared content item by detecting transmission of a tagged file associated with the shared content item.

5. The method of claim 4, wherein the tagged file includes information indicating a condition of the shared item of content.

6. The method of claim 1, wherein the compliance system adds or modifies a cookie on a browser of the first enrolled user based on search requests issued by the first enrolled user or shared items of content transmitted by the first enrolled user, said method further comprising using said cookie to deliver a targeted advertisement to the first enrolled user.

7. The method of claim 1, wherein the compliance system disables transmission of content that is not authorized for sharing on the P2P network.

8. The method of claim 1, wherein the first enrolled content owner and the first enrolled user are the same.

9. The method of claim 1, wherein at least one file with content owned by the enrolled content user is tagged with an identifier that causes the compliance system to credit the account of the enrolled content owner each time the file tagged with the identifier is transmitted from one enrolled user to another enrolled user.

10. A system for compensating content owners and users that share content on a peer to peer (P2P) network, comprising:
(a) an enrollment system that is accessed over the P2P network for (i) registering a plurality of users including a first enrolled user and a second enrolled user, wherein each of the plurality of users sends or receives one or more items of shared content using a node on the P2P network, (ii) registering a plurality of content owners that own at least some of the items of shared content, said plurality of content owners including a first enrolled content owner, and (iii) establishing a financial account for each user and content owner that registers using the enrollment system, wherein each financial account has information for crediting or debiting a user or content owner in response to the sharing of content on the P2P network; and
(b) a compliance system, coupled to the P2P network, that monitors transmission of items of shared content from nodes in the P2P network and receipt of items of shared content by nodes in the P2P network and, upon detection of the transmission of a shared item of content, owned by the first enrolled content owner, from the first enrolled user to the second enrolled user, the compliance system: (i) credits a financial account of the first enrolled user for transmission of the shared item of content; (ii) credits a financial account of the first enrolled content owner for transmission of the shared item of content; and (iii) charges a financial account of the second enrolled user for receipt of the shared item of content.
